(19) United States
(12) Patent Application Publication
(10) Pub. No.: US 2006/0159122 A1
(43) Pub. Date: Jul. 20, 2006

(54) Providing TDM channels to locations connected by networks implemented on broadcast medium

(75) Inventor: Manjuprakash Rama Rao, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/906,679

(22) Filed: Mar. 2, 2005

(30) Foreign Application Priority Data
Jan. 18, 2005 (IN) 35/CHE/2005

(51) Int. Cl. H04B 7/212; H04J 3/00; H04J 3/22; H04J 3/16

(52) U.S. Cl. 370/466; 370/442; 370/498

(57) ABSTRACT

Providing TDM channels to locations connected by networks implemented on broadcast medium. An (sender) interface equipment receives data bits of frames from a TDM node, forms data packets from the data bits, and sends the data packets on a broadcast network to a receiver interface equipment. The receiver interface equipment receives the data packets, generates frames for transmission to another TDM end node, and transmits the frames to the another TDM end node. The clock signal of the broadcast network may be used as a reference signal to provide a clock signal having an equal frequency to the clock signal used by the sender interface equipment to receive data on TDM channels.

### BACKGROUND OF THE INVENTION

1. Field of the Invention

The present invention relates to communication networks, and more specifically to a method to provide TDM communication over networks implemented on broadcast medium.

2. Related Art

Networks (“broadcast network”) are often implemented using broadcast medium. A broadcast medium generally refers to a medium in which the signal (typically carrying one or more data bits) transmitted by one node is received by all the nodes connected to the networks. Ethernet, DOCSIS, etc., are example networking protocols which are implemented based on broadcast mediums such as twisted pair, coaxial cable, etc., as is well known in the relevant arts.

Time division multiplexing (TDM) is another approach supporting implementation of networks. In TDM, the transmission duration (which is generally equal and repeats periodically) is divided into time slots, and each time slot is allocated for transmission of data related to a channel generally provided between two end nodes of a network (“transmission network” formed by all the nodes together). TDM techniques are used in several situations, such as in long distance transmission of data bits, as is also well known in the relevant arts.

In general, there is a need in the industry to extend one type of connectivity (as determined by the medium, protocols, etc.) over another type of connectivity.

### BRIEF DESCRIPTION OF THE DRAWINGS

The present invention will be described with reference to the following accompanying drawings.

Figure (FIG.) 1 is a block diagram illustrating the details of an example environment in which various aspects of the present invention can be implemented.

FIG. 2A is a flow chart illustrating the manner in which TDM channels on broadcast networks are supported at a sender end in an embodiment of the present invention.

FIG. 2B is a flow chart illustrating the manner in TDM channels on broadcast networks are supported at a receiver end in an embodiment of the present invention.

FIG. 3 is a block diagram illustrating the manner in which TDM channels can be provided in DOCSIS broadcast medium according to an aspect of the present invention.

FIG. 4 is a block diagram illustrating details of interface equipment enabling extension of TDM channels on broadcast networks, in an embodiment of the present invention.

FIG. 5 is a flow chart illustrating the manner in which a receiver TDM clock signal is generated in an embodiment of the present invention.

FIG. 6 is a flow chart illustrating the manner in which a sender interface equipment may operate to facilitate generation of a receiver TDM clock signal in an embodiment of the present invention.

FIG. 7 is a flow chart illustrating the manner in which a receiver interface equipment may generate a receiver TDM clock signal in an embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of present invention extends TDM channels over networks (“broadcast network”) based on broadcast medium by using a interface equipment (“sender interface equipment” for convenience) which receives data bits from a sender node on a TDM channel, forms data packets from the bits received on the TDM channel, and transports the data packets on the broadcast network. Another interface equipment (“receiver interface equipment”) receives the data packets from the broadcast network, and sends the bits again in the form of a TDM channel to a receiver node. As a result, TDM channels can be provided between locations (sender/receiver nodes) which are connected by a broadcast network in between.

A receiver interface equipment provided according to another aspect of the present invention generates a clock signal (“receiver TDM clock signal”) used for transmitting data on the TDM channel to the receiver node. In one embodiment, the receiver TDM clock signal is generated by dividing the clock signal (“network clock signal”) provided by the broadcast network based on the expected frequency of the TDM channel. One problem with such an embodiment is that the variations/drifts in the reference clock (“sender TDM clock signal”) used for the TDM channel at the sender node, can lead to loss of data bits.

Another aspect of the present invention overcomes such a problem by communicating from the sender interface equipment to the receiver interface equipment the present relative rate of the sender TDM reference clock signal with respect to the broadcast network clock signal. As the network clock signal is also available at the receiver interface equipment, a clock signal substantially equaling the present rate of the reference clock can be generated and provided to transmit data bits to the receiver node. Due to the communication of the present relative rate and generating the receiver TDM clock signal based on the present relative rate, a receiver interface equipment may generate a receiver TDM clock signal which accurately tracks any drifts in the sender TDM clock signal.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Example Environment

FIG. 1 is a block diagram of an example networking environment in which various aspects of the present invention can be implemented. The environment is shown containing TDM nodes 110 and 170, interface equipment 120 and 160, and network 150. Each block is described below in further detail.

Network 150 is implemented using broadcast medium such as DOCSIS (networking protocol), and each of paths 125 and 156 carries signals as per the standards pertaining to network 150. TDM nodes 160 and 170 represent the terminal points of TDM channels, and paths 112 and 167 carry the signals as per the standards pertaining to the TDM channels.

Interface equipment 120 and 160 operate to extend the TDM channel originating at TDM node 110 to TDM node 170, and vice versa using network 150 as the medium. As a result, TDM channels can be provided between TDM nodes 110 and 170. The manner in which interface equipment 120 and 160 may operate to provide such extension is described below with various examples.

3. Extending TDM Channels Over Broadcast Networks

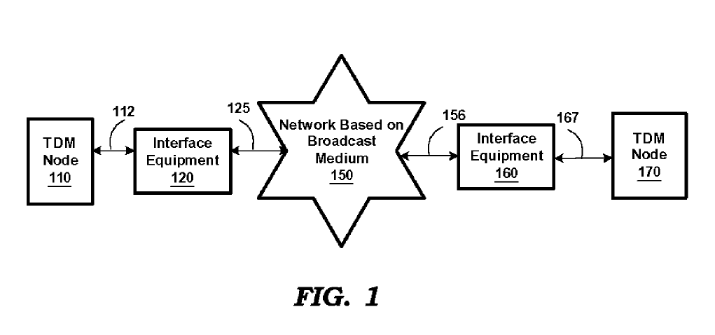

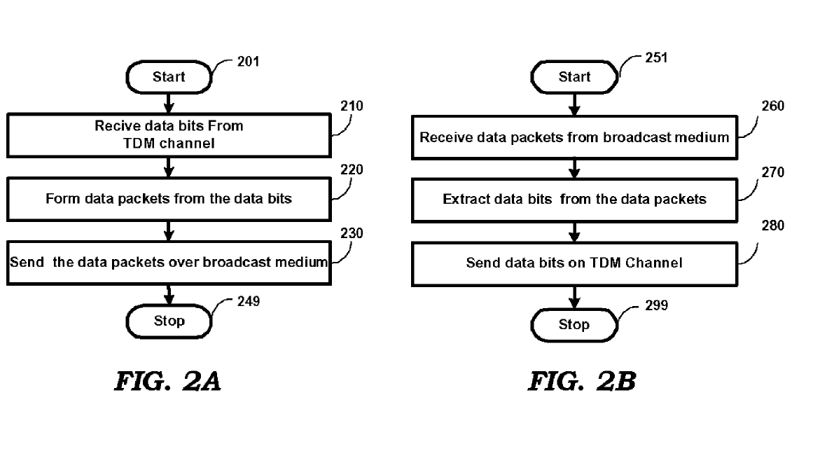

FIGS. 2A and 2B together illustrate the manner in which interface equipment operate to extend TDM channels over broadcast networks according to an aspect of the present invention. Merely for illustration, the figures are described with respect to a scenario in which TDM node 110 sends data bits on a TDM channel, which is received at TDM node 170. However, it should be appreciated that TDM node 170 can also send data bits on a TDM channel, which are received by TDM node 110. In addition, it should be appreciated that the features of FIGS. 2A and 2B can be implemented in other nodes and environment as well.

Continuing with exclusive reference to FIG. 2A, the flow chart begins in step 201, in which control transfers to step 210. In step 210, interface equipment 120 receives data bits from TDM channel on path 112. In general, TDM channels carry data bits according to a communication standard (e.g., such as T1/E1 digital transport approaches described for example in, G.703/G.704 Standard Available from the International Telecommunications Union, Place des Nations, 1211 Geneva 20, Switzerland), and accordingly data bits can be received by implementing interface equipment 120 consistent with the standard.

In step 220, interface equipment 120 forms data packets from the data bits. The data packets need to be encapsulated with appropriate header data (according to the standard of broadcast network 150) such that the packets will be delivered by network 150 to interface equipment 160 In the unstructured mode of operation, the interface equipment forms data packets from all data bits of TDM interface disregarding any framing imposed on the data stream. In structured mode of operation, the interface equipment forms data packets from only a subset of the entire data bits received on the TDM interface.

In step 230, interface equipment 120 sends the data packet over broadcast network 150. In general the data packets need to be sent in accordance with the standards/interface using which network 150 is implemented, and interface equipment 120 needs to be implemented consistent with the corresponding standards/interface. The flow-chart ends in step 249.

Interface equipment 160 needs to operate cooperatively with the approach(es) of above to enable the TDM channels to be extended using broadcast networks. The manner in which interface equipment 160 may need to be implemented for such operation, is described below with reference to FIG. 2B.

With reference to FIG. 2B, the flow chart (of FIG. 2B) begins in step 251 and control transfers to step 260. In step 260, interface equipment 160 receives data packets from the broadcast medium (broadcast network 150). In general, data packets are received consistent with the standards/interfaces using which broadcast network 150 is implemented.

In step 260, interface equipment 160 extracts data bits from the data packets. Step 260 may be implemented to complement the operation of step 220. In step 270, interface equipment 160 sends the extracted data bits on TDM channel consistent with the interface requirements of TDM node 170 on path 167. The flow-chart ends in step 299.

From the above, it may be appreciated that TDM channels can be supported between TDM nodes 110 and 170 by implemented the features of both FIGS. 2A and 2B in each of interface equipment 120 and 160. It should be further appreciated that interface equipment 120 and 160 need to be designed to address various other considerations as well, depending on the implementation of network 150, etc. The description is continued with respect to some example network implemented using DOCSIS protocol.

4. TDM Channel Extension Over DOCSIS Network

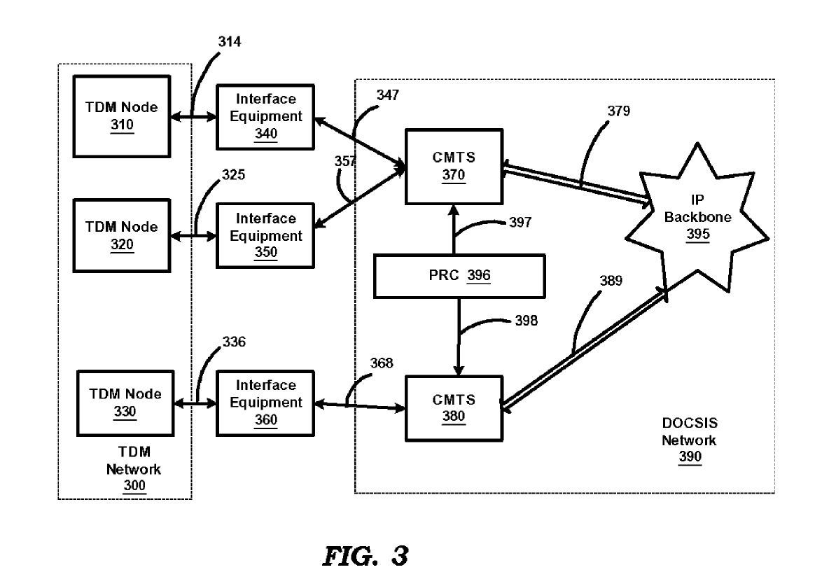

FIG. 3 illustrates an example environment in which TDM channels are extended over DOCSIS network (an example of a broadcast network). The environment is shown containing TDM nodes 310, 320, and 330, interface equipment 340, 350, and 360, and DOCSIS network 390. Each system is described below in further detail.

TDM nodes 310,320,330 represent nodes of a transmission network implemented using TDM technology such as T1/E1. Though not shown for conciseness, the transmission network generally contains many nodes. Each of TDM nodes 310 320,330 operate to provide one or more TDM channels. An aspect of the present invention enables the TDM channels to be extended over DOCSIS network, as described below in further detail.

DOCSIS network 390 represents an example broadcast network providing transport of data packets between interface equipments 340, 350, and 360. DOCSIS network 390 is shown containing cable modem terminal stations (CMTS) 370 and 380, IP backbone 395 and primary reference clock (PRC) 396. Each component is described below in further detail. For further detail on DOCSIS protocol and the components, the reader is referred to a document entitled, “Data-Over-Cable Service Interface Specifications DOCSIS 2.0, Radio Frequency Interface Specification”, Identifier: CM-SP-RFIv2.0-I07-041210, available from Cable Television Laboratories, Inc., 858 Coal Creek Circle, Louisville, Colo. 80027-9750, Phone: 303.661.9100, www.cablelabs.com.

IP backbone 395 forwards packets among CMTS 370 and 380 according to Internet Protocol (IP) well known in the relevant arts. PRS 396 provides a high quality reference clock signal to CMTS 370 and 380. In one embodiment, the CMTS derives the 10.24 MHz DOCSIS protocol timestamps from the PRS. It may be appreciated that CMTS units can operate from other stable clock references as well.

CMTS 370 sends on cables 347, 357, and 368 modulated signals representing the data bits to be sent to corresponding interface equipments 340, 350 and 360. The data bits may be received from other interface equipment or IP backbone 396. Similarly, CMTS 370 recovers data bits (contained in data packets) represented by modulated signals received on cables 347, 357 and 368, and forwards the data packets to other interface equipment or IP backbone 396.

CMTS 370 provides sends data packets with time stamps according to DOCSIS protocol on each of cables 347, 357 and 368. The clock signal can then be recovered by each interface equipment 340, 350 and 360 from the packets with time packets according to DOCSIS standard in a known way. In an embodiment described below, the recovered clock signal is used to generate a TDM clock signal for transmission of data to TDM nodes 310, 320 and 330.

Interface equipments 340,350,360 extend the TDM channels using DOCSIS network 390 as the transport medium according to various aspects of the present invention. As a result, TDM channels on each of paths 314, 325 and 336 can be extended on any of the other paths. The manner in which each of the interface equipments can be implemented is described below in further detail with examples.

5. Interface Equipment

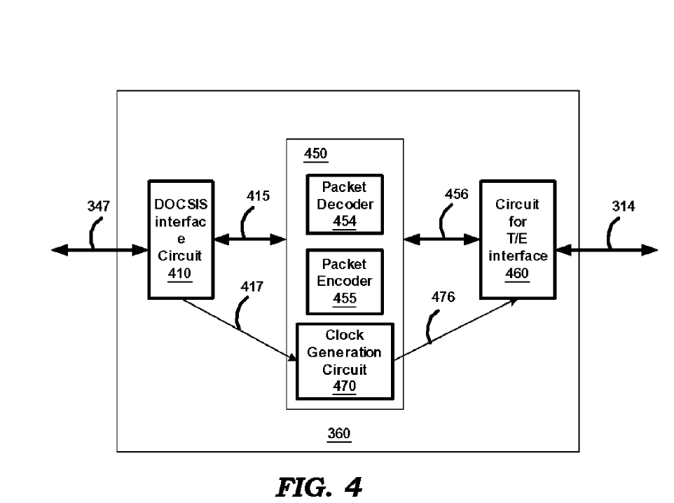

FIG. 4 is a block diagram illustrating the details of implementation of interface equipment according to various aspect of present invention. Interface equipment 360 is shown containing DOCSIS interface circuit 410, T1/E1 interface circuit 460, and packet forming unit 450 containing packet encoder 455, packet decoder 454 and clock generation unit 470. Each block is described below in further detail.

DOCSIS interface circuit 410 (broadcast interface circuit) receives modulated signal (transmitted on the cables and representing data) through cable 347 and demodulate the modulated signal to extract data packets and the reference clock signal. Further, DOCSIS interface circuit 410 provides the received data packet to packet decoder unit 454 and the reference clock signal (DOCSIS Clock) to clock generation unit 470. Similarly, DOCSIS interface circuit 410 receives data packets from packet encoder unit 455, and sends a modulated signal containing the packets on cable 347 according to DOCSIS protocol.

T1/E1interface circuit 460 (TDM interface circuit, in genera) receives data bits from the packet decoder unit 454, and a clock signal from the clock generation unit 470, and transmits the data bits as a TDM channel on path 314 using the clock signal. Similarly, T1/E1 interface circuit 460 receives TDM channel on path 314, extracts data bits and TDM channel clock reference, and provides extracted data bits to packet encoder unit 454.

Packet encoder 455 receives data bits (TDM Channels) from the T1/E1 interface circuit 460 and forms packets from the data bits (with appropriate headers for delivery at the interface equipment at the other end). The packets thus formed are sent to DOCSIS interface circuit 410. In an embodiment, the packets are formed according to IP protocol using (UDP, RTP). TDM channels belonging to a single T1/E1 frame can be transmitted in single packet or TDM channels belonging to multiple frames can be transmitted in a single packet based on the end to end delay considerations.

Since the rate of arrival of TDM channels on T1/E1 interface is on regular basis (i.e., uniform intervals), the UGS/UGS-AD scheduling scheme of DOCSIS can be used for transmission of the data packets to guarantee Quality of Service on the DOCSIS access. The parameters of the UGS/UGS-AD service flows can be pre-provisioned or dynamically provisioned based on the delay, jitter and related performance considerations. The TOS byte of the IP header carrying the TDM channel data is configurable and typically the IP backbone is setup for maximum reliability for the packets.

Certain optimizations for bandwidth utilization is possible when transporting data packets. There are certain TDM interfaces such as T3 (DS3) which allows for idle code to indicate that the TDM interface is idle and not bearing any payload. In general the interface equipment can be provisioned to detect idle codes in the incoming TDM interface and take certain actions when idle codes are detected on one or all TDM channels. On detection of the idle code, the interface equipment does not send data packets but instead transmit one or more infrequent “idle code packets” to remote end. This approach optimizes the bandwidth utilization in the DOCSIS access and also optimizes the utilization of network resources in the IP backbone.

More specifically on the DOCSIS access when the idle code is detected when utilizing UGS-AD service flow the interface equipment transmits a DOCSIS service flow management message to CMTS to suspend issuing grants and enter the rtPS scheduling approach. Subsequently when the TDM interface start to contain non idle code data then the interface equipment can signal to CMTS to switch back to UGS service flow and start sending grants at requested intervals to send payload data packets. The remote end on detecting the idle code packet will start to repetitively transmit the provisioned idle code pattern onto the TDM interface until it receives the subsequent data packets.

Packet decoder 454 receives data packets from the DOCSIS interface circuit 410, extracts the data bits from data packet, and sends the data bits to T1/E1 circuit 460 in the form of frames. The decoding generally needs to be consistent with encoding operation of packet encoder 455. Packer decoder 454 and packet encoder 455 may be provided with appropriate buffering capability to facilitate framing and packetization of data bits.

Clock generation unit 470 generates the (receiver) TDM clock signal used to transmit data bits/frames on 314. In general, the frequency of the receiver TDM clock signal needs to equal the frequency of the sender TDM clock signal (e.g., on path 325 assuming TMD node 320 is the sender node). Achieving such equality enables avoiding bit loss. The manner in which clock generation unit 470 can be implemented is described below with examples.

6. Generating TDM Clock Signal

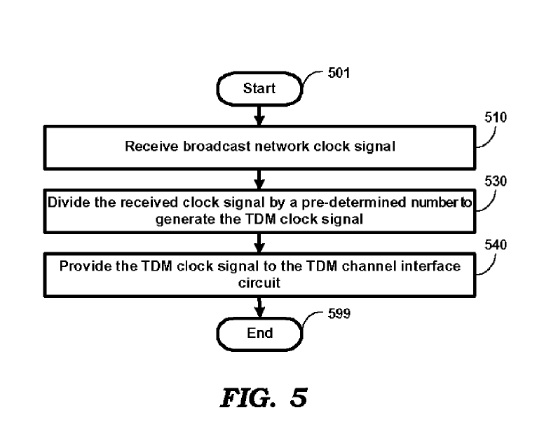

FIG. 5 is a flow chart illustrating the manner in which clock generation unit 470 may generate a TDM clock signal according to an aspect of the present invention. The flow chart begins in step 501 in which control immediately passes to step 510. In step 510, clock generation unit 470 receives a broadcast network clock signal.

In step 530, clock generation unit 470 divides the received clock signal by a pre-determined number to generate the TDM clock signal. The pre-determined number is based on an expected frequency of the sender TDM clock signal. For example, assuming that the broadcast network clock signal is of 10.24 MHz, and expected frequency of sender TDM clock signal (T1/E1) equals 2.048 MHz, the pre-determined number equals 5 (i.e., 10.24/2.048=5).

In step 540, clock generation unit 470 provides the TDM clock signal to the TDM channel interface circuit (T1/E1 interface circuit 460). The method ends in step 599. Thus, using the approach of method of FIG. 5, a suitable TDM clock signal can be generated.

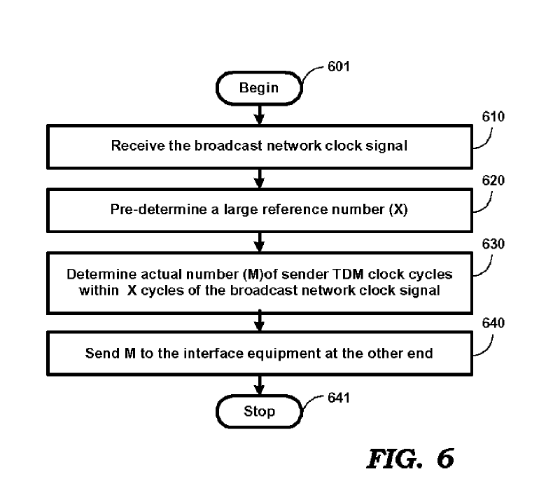

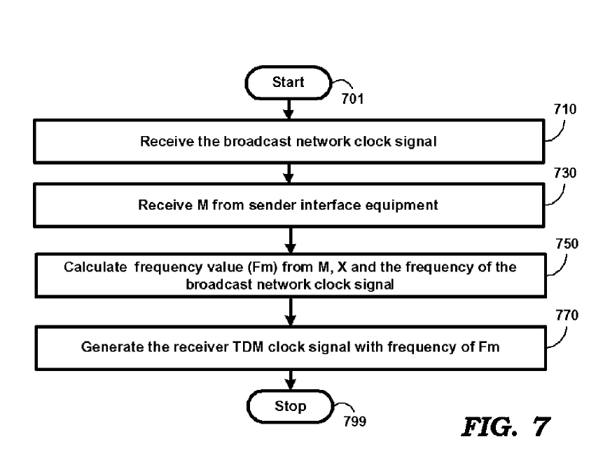

However, one problem with the above approach is that any variations in the sender TDM clock signal (due to reasons such as drift and jitter) would not be tracked at the receiver TDM clock signal, which would lead to a loss of the data bits. In general, it is desirable to avoid such data loss. The manner in which such data loss can be avoided is described below with reference to FIGS. 6 and 7.

Broadly, the approach of FIG. 6 operates to generate a value (M) indicating the present relative frequency of the sender TDM clock signal with respect to the broadcast network clock signal. The value M is sent to the interface equipment at the other end and the receiver TDM clock signal is generated with the desired frequency using M. FIGS. 6 and 7 are described below in further detail. Both FIGS. 6 and 7 are described with respect to FIG. 4 merely for illustration.

With reference to the flow-chart of FIG. 6, the flow-chart begins in step 601, in which control immediately passes to step 610. In step 610, clock generation unit 470 receives the broadcast network clock signal having a frequency of (Fb). In step 620, a reference number (X) is pre-provisioned. The reference number X may be chosen to be large enough such that the corresponding time duration (of step 630) would encompass the corresponding data payload bits being sent to remote equipment. The same value (X) needs to be provisioned at the receiver interface equipment (for generation of the TDM clock signal), as will be apparent from the description of FIG. 7.

Continuing with reference to FIG. 6, in step 630, clock generation unit 470 determines M, representing a number of clock cycles of sender TDM clock signal occurring within X number of clock cycles of the broadcast network clock signal. Thus, M represents a relative frequency of sender TDM clock signal with respect to the broadcast network clock signal. It should be other approaches can be used to determine such a relative frequency. For example, the number of clock signals of the broadcast network clock signal occurring in a pre-determined number of cycles of TDM clock signal, may be determined.

In step 640, the number M is sent to the interface equipment at the other end. M can be sent according to any compatible approaches implemented in the two interface equipment (exchanging M). In one embodiment, a suitable format is provided within the framework of TCP/IP to send/receive M. For example, M may be provided within the same packet containing the corresponding data bits. The implementation of such approaches will be apparent to one skilled in the relevant arts by reading the disclosure provided herein. The method ends in step 699. The manner in which M can be used (by the receiver interface equipment) to generate the receiver TDM clock signal is described below with respect to FIG. 7.

FIG. 7 is a flow-chart illustrating the manner in which clock generation unit 470 may generate a receiver TDM clock signal using X, M and the Fb (frequency of the broadcast clock signal). The flow-chart starts in step 701, in which control immediately transfers to step 710. In step 710, clock generation unit 470 receives the broadcast network clock signal having a frequency of (Fb).

In step 730, clock generation unit 470 receives M from sender interface equipment. The value may be received directly from decoder 455 (which parses the packet for value of M). In step 740, clock generation unit 470 calculates the frequency value (Fm) from M, X, an Fb (the frequency of the broadcast clock signal), for example, according to the below equation:
Fm=Fb*(M/X),
wherein * and / respectively represent the multiplication and division operation.

In step 770, clock generation unit 470 generates the receiver TDM clock signal with a frequency equaling Fm, calculated above. Due to the approach thus use, the generated receiver TDM clock may track the present frequency of the sender TDM clock signal. The method ends in step 799.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of providing a time division multiplexing (TDM) channel between a first node and a second node, said method comprising:
receiving a plurality of data bits on said TDM channel from said first node;
forming one or more data packets from said plurality of data bits;
transporting said one or more data packets on a network based on a broadcast medium; and
sending said plurality of data bits contained in said one or more data packets to said second node in the form of said TDM channel.

2. The method of claim 1, further comprising generating a receiver TDM clock signal having a frequency equaling the frequency of a sender TDM clock signal, wherein said receiver TDM clock signal is used by said sending and said sender TDM clock signal is used by said receiving.

3. The method of claim 2, wherein said generating comprising:
receiving a broadcast network clock signal which is generated within said network; and
dividing said broadcast network clock signal by a desired number computed according to the expected frequency of said sender TDM clock signal.

4. The method of claim 2, wherein said generating comprises:
determining a number X representing a relative frequency of said sender TDM clock signal with respect to a broadcast network clock signal, wherein said a broadcast network clock signal is generated within said network; and
calculating a frequency of said receiver TDM clock signal according to said number X.

5. The method of claim 4, wherein said determining comprises measuring a number of clock cycles of said sender TDM clock signal in a pre-determined number of clock cycles of said broadcast network clock signal.

6. The method of claim 1, wherein said network is implemented according to DOCSIS.

7. The method of claim 1, wherein said TDM channel represents T1/E1 channel.

8. An interface equipment enabling a time division multiplexing (TDM) channel between a first node and a second node, said interface equipment comprising:
a time division multiplexing (TDM) interface circuit for receiving a first plurality of data bits on said TDM channel from said first node;
a packet forming unit forming one or more data packets from said plurality of data bits; and
a broadcast interface circuit for sending said one or more data packets on a network based on broadcast medium,
wherein another interface equipment receives said one or more data packets and sends said plurality of data bits on said TDM channel to said second node.

9. The interface equipment of claim 8, wherein said broadcast interface circuit receives a second plurality of data packets on said network based on broadcast medium from said second node, said packet forming unit forming a plurality of frames for transmission on said TDM channel to said first node, said TDM interface circuit sending said plurality of frames to said first node in the form of said TDM channel.

10. The interface equipment of claim 9, further comprising a clock generation unit for generating a receiver TDM clock signal having a frequency equaling the frequency of a TDM clock signal using which said another interface equipment receives data bits on said TDM channel,
wherein said TDM interface circuit uses said receiver TDM clock signal to send said plurality of frames to said first node.

11. The interface equipment of claim 10, wherein said clock generation unit operates to:
receive a broadcast network clock signal which is generated within said network; and
divide said broadcast network clock signal by a desired number computed according to the expected frequency of said sender TDM clock signal to generate said receiver TDM clock signal.

12. The interface equipment of claim 10, wherein said clock generation unit operates to:
determine a number X representing a relative frequency of a sender TDM clock signal with respect to a broadcast network clock signal, wherein said broadcast network clock signal is generated within said network and said first plurality of data bits are received by said TDM interface circuit using said sender TDM clock signal; and
send X to said another interface equipment.

13. The interface equipment of claim 12, wherein said clock generation unit measures a number of clock cycles of a sender TDM clock signal in a pre-determined number of clock cycles of said broadcast network clock signal.

14. The interface equipment of claim 9, wherein said network is implemented according to DOCSIS.

15. The interface equipment of claim 9, wherein said TDM channel represents T1/E1 channel.

16. A system comprising:
a first time division multiplexing (TDM) node and a second TDM node;
a network based on broadcast medium;
a first interface equipment connected between said first TDM node and said network; and
a second interface equipment connected between said second TDM node and said network,
said first interface equipment and said second interface equipment providing a TDM channel between said first TDM node and said second TDM node by sending and receiving packets on said network based on broadcast medium.

17. The system of claim 16, wherein said first interface equipment receives data bits on said TDM channel and forwards said data bits to said second interface equipment in the form of a packet on said network, said second interface equipment receiving said packet, and forwarding said bits in the form of said TDM channel to said second TDM node.

18. An apparatus providing a time division multiplexing (TDM) channel between a first node and a second node, said apparatus comprising:
means for receiving a plurality of data bits on said TDM channel from said first node;
means for forming one or more data packets from said plurality of data bits;
means for transporting said one or more data packets on a network based on a broadcast medium; and
means for sending said plurality of data bits contained in said one or more data packets to said second node in the form of said TDM channel.

19. The apparatus of claim 9, further comprising means for generating a receiver TDM clock signal having a frequency equaling the frequency of a sender TDM clock signal, wherein said receiver TDM clock signal is used by said sending and said sender TDM clock signal is used by said receiving.

20. The apparatus of claim 19, wherein said means for generating operates to:
receive a broadcast network clock signal which is generated within said network; and
divide said broadcast network clock signal by a desired number computed according to the expected frequency of said sender TDM clock signal.

21. The apparatus of claim 19, wherein said means for generating operates to:
determine a number X representing a relative frequency of said sender TDM clock signal with respect to a broadcast network clock signal, wherein said a broadcast network clock signal is generated within said network; and
calculate a frequency of said receiver TDM clock signal according to said number X.

22. The apparatus of claim 21, wherein said means for determining measures a number of clock cycles of said sender TDM clock signal in a pre-determined number of clock cycles of said broadcast network clock signal.

23. The apparatus of claim 9, wherein said network is implemented according to DOCSIS.

24. The apparatus of claim 9, wherein said TDM channel represents T1/E1 channel.
